(19) United States
(12) Patent Application Publication
(10) Pub. No.: US 2018/0276558 A1
(43) Pub. Date: Sep. 27, 2018

(54) CONTENT RATING CLASSIFICATION WITH COGNITIVE COMPUTING SUPPORT

(71) Applicant: International Business Machines Corporation, Armonk, NY (US)

(72) Inventors: Rafael Rossi de Mello Brandao, Ipanema (BR); Renato Fontoura de Gusmao Cerqueira, Barra da Tijuca (BR); Marcio Ferreira Moreno, Copacabana (BR)

(21) Appl. No.: 15/464,925

(22) Filed: Mar. 21, 2017

(51) Int. Cl. G06N 99/00; G06N 5/04

(52) U.S. Cl. CPC G06N 99/005; G06N 5/046

(57) ABSTRACT

A method for classifying content includes receiving the content; identifying a ratings jurisdiction and regime for the content; accessing a knowledge base for a trained model according to the ratings jurisdiction and regime; classifying the content by testing the content against the trained model; and providing to a user the classification of the content. Optionally, the method includes receiving, from the user, a classification feedback of the content; and updating the trained model responsive to the content and the classification feedback.

### BACKGROUND

The present invention relates to the electrical, electronic, and computer arts, and more specifically, to implementation of cognitive systems for content rating classification.

Entertainment companies have to comply with audiovisual publication and marketing regulations across different countries. This includes complying with rating systems to address suitability for audiences in terms of issues of controversial or provocative nature. To accomplish this they need to hire experts who know all the classification rating rules according to the different countries to which they want to market their products. All content must be consumed and analyzed by these experts before publication, demanding their focus and thorough attention to ensure classification consistency during the rating process.

In an effort to reduce expert time and associated costs, it is known to classify video still frames by comparing feature vectors of individual frames to the feature vectors of image class statistical models, which are developed using the feature vectors of training images according to expert classifications of the training images. Hidden Markov modeling may be used to account for class transitions from frame to frame.

Additionally, it is known to classify video sequences according to pixel decomposition or primitive attribute decomposition. As an example of primitive attribute decomposition, images randomly selected from video sequences can be classified based on automated analysis of shapes, skin tones, skin texture, accompanying text, and curvatures.

### SUMMARY

Principles of the invention provide techniques for content rating classification with cognitive computing support. The proposed method and system generally assist the process of classifying content that should be rated as appropriate for a given audience, considering local legislation and rules. It uses a cognitive computing system that understands classification rules and supports the task of identifying concepts that may be considered appropriate for a given age range. For instance, certain content of controversial or provocative nature are commonly rated as inappropriate for underage audiences in many countries, while content of less controversial or provocative nature is rated as appropriate for these audiences. The proposed invention enhances the prior art by providing automatic suggestions of content classification ratings, over different types of media (such as, video, audio, text, images). As one example, a video stream may be correlated with an accompanying audio stream and text to enhance the accuracy of suggested content classification ratings.

In one aspect, an exemplary method includes receiving content; identifying a ratings jurisdiction and regime for the content; accessing a knowledge base for a trained model according to the ratings jurisdiction and regime; classifying the content by testing the content against the trained model; and providing to a user the classification of the content.

Embodiments of the invention may include a non-transitory computer readable medium that embodies computer executable instructions which when executed by a computer cause the computer to implement the exemplary method above discussed.

Other embodiments of the invention may include an apparatus that includes a memory and at least one processor, coupled to said memory, and operative to implement the exemplary method above discussed.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. For example, one or more embodiments provide one or more of:

Improved accuracy of automated content classification.

Continuous training of an automated content classification system.

Support for defining and reusing rules for content classification rating systems, according to specific regulations.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a cloud computing environment according to an embodiment of the present invention;

FIG. 2 depicts abstraction model layers according to an embodiment of the present invention;

FIGS. 3 and 4 depict a cognitive system for content classification rating according to embodiments of the present invention;

FIG. 5 depicts in flowchart form steps of a first method according to embodiments of the present invention implemented by the cognitive system of FIGS. 3 and 4;

FIG. 6 depicts in flowchart form steps of a second method according to embodiments of the present invention implemented by the cognitive system of FIGS. 3 and 4;

FIG. 7 depicts in flowchart form steps of a third method according to embodiments of the present invention implemented by the cognitive system of FIGS. 3 and 4; and

FIG. 8 depicts a computer system that may be useful in implementing one or more aspects and/or elements of the invention, also representative of a cloud computing node according to an embodiment of the present invention.

### DETAILED DESCRIPTION

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

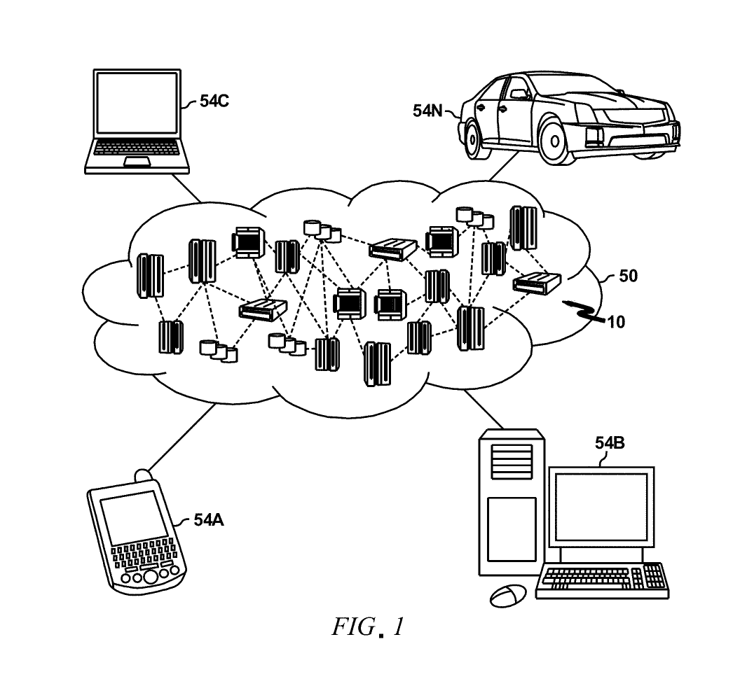

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

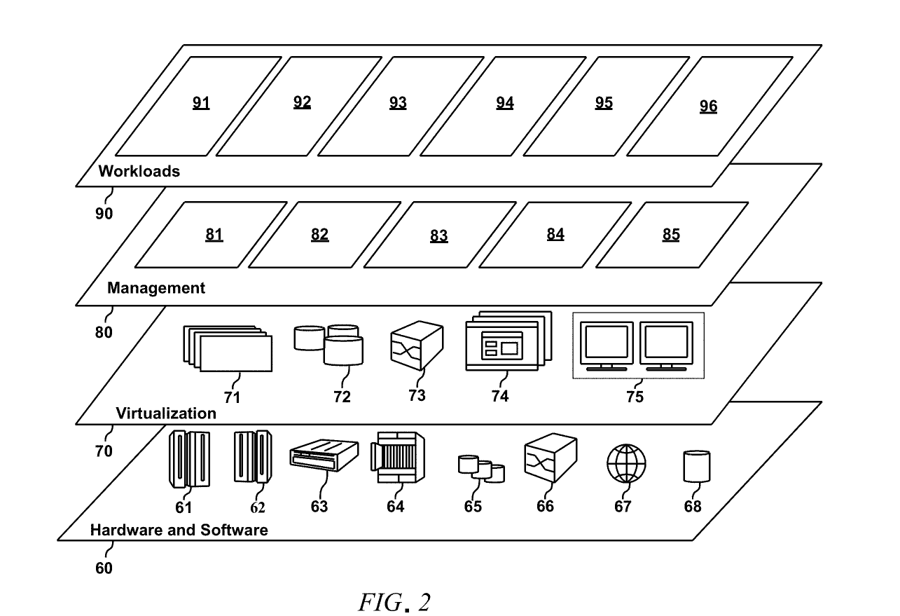

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and a cognitive computing system 96 for content classification rating.

The present disclosure describes embodiments of a Cognitive Content Rating Assistant (CCRA) configured to support domain experts when modeling defined rules for content classification rating systems according to any related legislation. In this sense, the CCRA may assist both structuring the knowledge around this categorization process and suggesting content classification ratings. Many countries specify how media content should be classified in order to comply with what is considered appropriate subjects (or concepts) for specific audiences. These rules can be modeled as statements (for instance, subject-predicate-object triples), along with categorized content samples containing scenes, samples and snippets of media (including video, audio, image or text samples) representing the desired classification. These samples are used as a training corpus to the cognitive system, which can be used posteriorly to assist classification of new content targeted to a region whose rules were previously modeled.

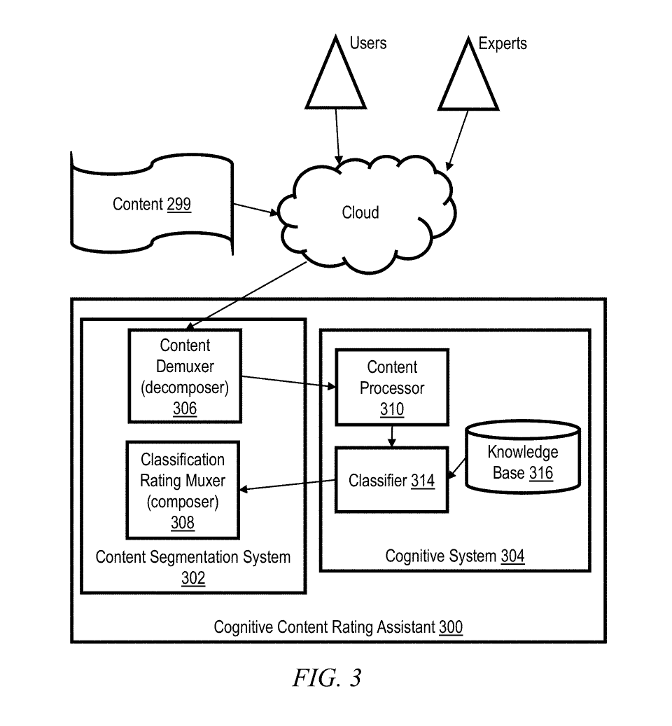

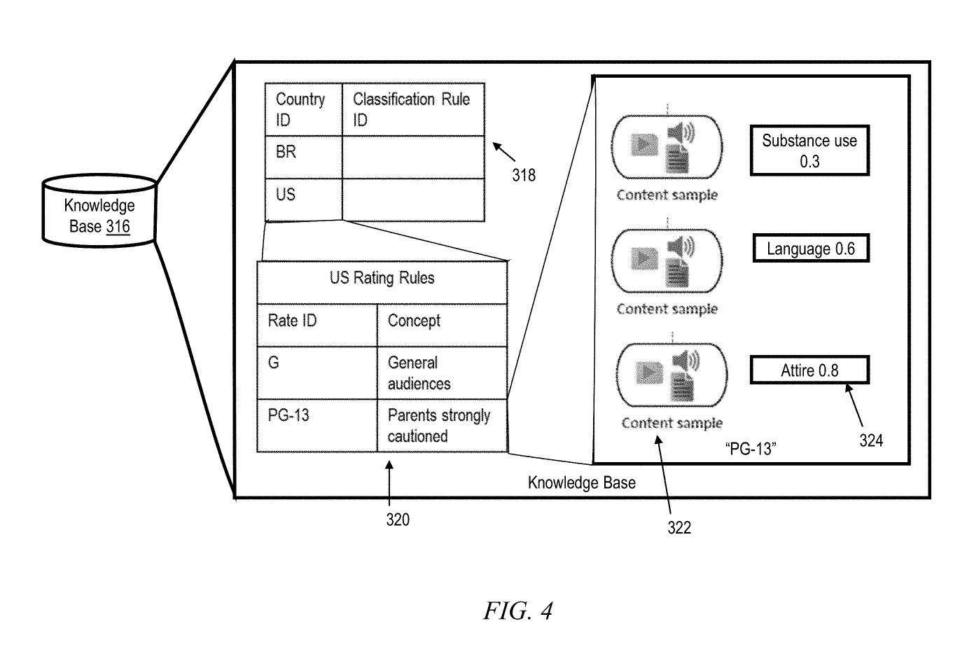

Referring to FIGS. 3 and 4, a CCRA 300 according to embodiments of the invention includes a content segmentation system 302 and a cognitive system 304. The content segmentation system 302 is useful in case users enter bundled content 299 (grouped sets of media) to be classified in a batch. The content segmentation system 302 includes a content demuxer/decomposer 306 for disaggregating grouped sets of media, as well as a content rating muxer/composer 308 for aggregating content classification rating results. The cognitive system 304 does the work of suggesting content classification ratings and includes a content processor 310, a classifier 314, and a knowledge base 316.

Referring specifically to FIG. 4, the knowledge base 316 is a repository of previously rated content that includes ratings 318, rules for ratings 320, content samples 322 relevant to the ratings, and ratings feature vectors or semantics 324 of the content samples. The previously rated content is grouped by jurisdiction (e.g., United States, Brazil, etc.) and by regime (e.g., within the United States the Motion Picture Association of America administers a rating regime for movies while the TV Parental Guidelines Monitoring Board administers a different rating regime for television shows). For example, under the U.S. TV ratings regime, the rating of TV-Y7 could be matched with content samples from SpongeBob SquarePants® along with feature vectors and semantics extracted from those content samples. For purposes of this disclosure, “feature vectors” means n-dimensional arrays of numbers that represent distinguishing characteristics of an object or concept of interest. Features include, but are not limited to, frequency, timber, beats, spectrum, pixel intensity, color components, length, area, gradient magnitude, gradient direction among others. On the other hand, “semantics” means higher-level meaning that is inferred from the feature vectors—such as substances use, strong language, or revealing attire as illustrated in FIG. 4. Semantics can be inferred from the feature vectors using supervised learning algorithms (another trained model, possibly a component of the CCRA), which can be updated by user input.

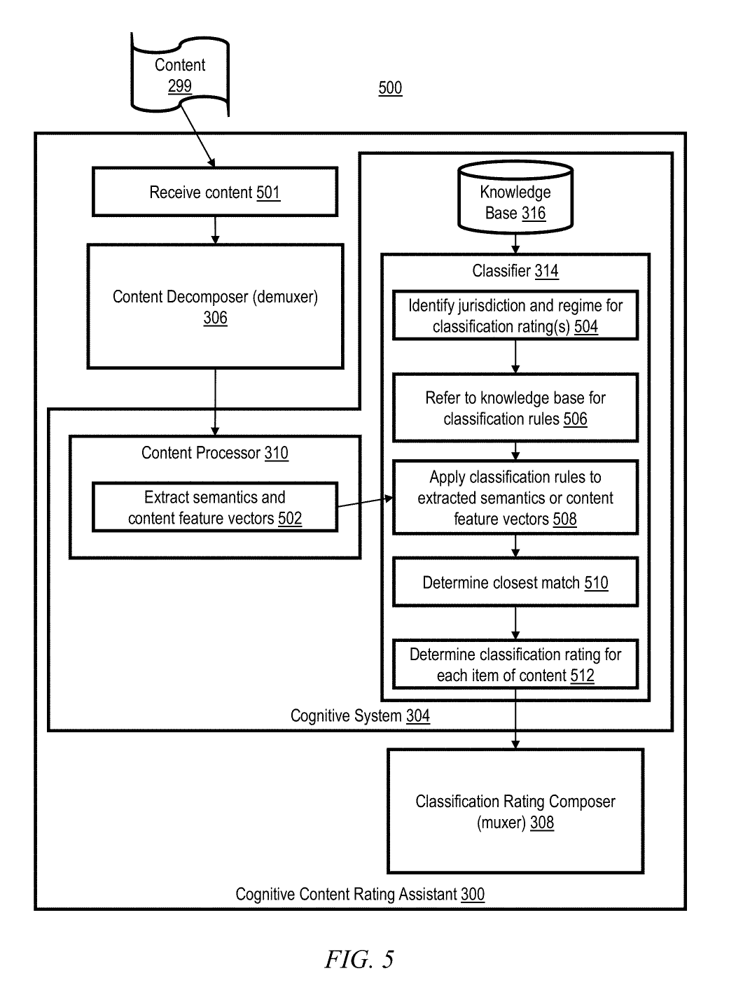

Referring again to FIG. 3, and also to the method 500 steps as shown at FIG. 5, according to certain implementations of the invention the content decomposer 306 receives 501 one or more items of content 299 (be it video, audio, text, or image) and passes the item or items to the content processor 310. The content processor 310 extracts 502 semantics from the one or more items of content or from feature vectors of the one or more items of content. For example, the classifier 314 extracts 502 the semantics based on supervised learning algorithms, including but not limited to, Support Vector Machines (SVM), neural networks, decision trees, naive Bayes and others. These algorithms may be used independently or in combination. The classifier 314 identifies 504 a jurisdiction and regime for which the one or more items of content are to be rated. The classifier 314 then refers 506 to the knowledge base for classification rules that are relevant to the identified rating regime. The classifier 314 applies 508 the classification rules to the content feature vectors or to the semantics extracted from the content. Based on the classification rules, the classifier determines 512 for each item of content what classification rating should be suggested under the identified rating regime. For example, given a video stream (intended for U.S. television) that includes frames with content feature vectors that generate semantics of mild comedic violence, the classifier would determine a classification rating of TV-Y7. Given an audio stream (also intended for U.S. television) that includes segments that generate semantics of strong language, the classifier would determine a classification rating of TV-Y14. Examples of other content feature vectors and/or semantics inferred from those vectors are envisioned. For example, semantics of controversial or provocative nature might include one or more of the following: depictions of revealing attire, violence, substance use, strong language, impudence, etc. Examples of less controversial or provocative semantics might include: educational material, nature series, etc.

The classification rating composer 308 combines the ratings for the different items of content. For example, given the video stream and audio stream mentioned just above as part of a single bundled content, then the classification rating composer 308 would assign an overall rating of Y-14. In one or more embodiments of the present invention, the classification rating composer 308 assigns a highest or most restrictive rating out of all content items in a bundled content.

The results of the classification are presented to users along with content anchors, which represent temporal segments (e.g., time intervals of a video or audio) or spatial coordinates (e.g., image regions, paragraph number of a text document, etc.) that identify fragments of interest in the given content (i.e., the frames, clips, or areas that have produced the content feature vectors or semantics that are the basis for the classification rating).

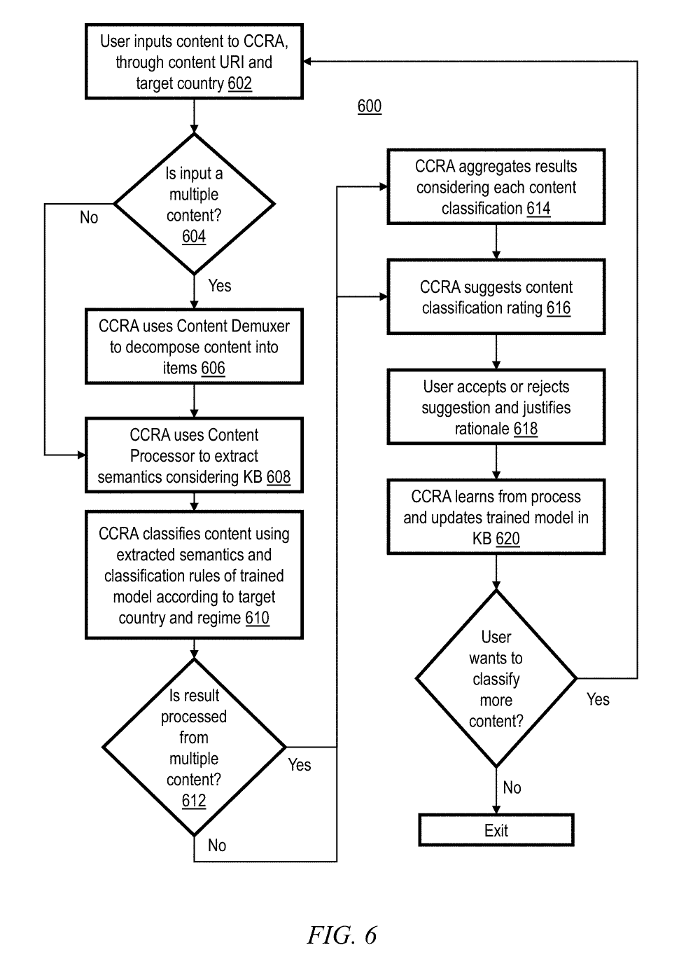

Referring to FIG. 6, some embodiments of the invention implement a method 600 in which a user inputs 602 content 299 to the CCRA 300, through content URI and target country. The CCRA assesses 604 whether the input is a bundled content. If yes, the CCRA uses the content demuxer 306 to decompose 606 the content into items. If no, or after the content has been decomposed into items, the CCRA uses the content processor 310 to extract 608 semantics considering the knowledge base 316.

The CCRA then classifies 610 the content 299 using the extracted semantics or feature vectors and classification rules of a trained model for the target country and regime. The model is trained to develop its classification rules by supervised learning algorithms, including but not limited to, Support Vector Machines (SVM), neural networks, decision trees, naive Bayes and others. The trained model is based on training data obtained from content samples correlated to ratings that are specific to target countries (e.g., “United States”) and regimes (e.g., “television”). According to certain implementations of the exemplary method, the training data includes feature vectors of the content samples; according to other implementations, the training data includes semantics extracted from the content samples or from the feature vectors using another trained model.

The CCRA 300 determines 612 whether the classification rating result has been processed from bundled content. If yes, then the CCRA aggregates 614 results considering each content classification. In one or more embodiments of the present invention, when aggregating results, the CCRA assigns a highest or most restrictive rating out of all content items in a bundled content. If no, or after aggregating results, the CCRA suggests 616 a content classification rating. The user accepts or rejects 618 the suggestion and justifies rationale for doing so. The rationale for accepting or rejecting the suggestion is in the form of content samples and a user-assigned classification rating of the content samples. The CCRA learns from this process and updates 620 the trained model in the knowledge base 316. The CCRA updates the trained model by using the content samples as training data for the model and using the user-assigned classification rating as a target for the model. In case the user wants to classify more content, the method loops to input more content; otherwise, the method exits.

One or more embodiments of the invention may combine various features and elements of the exemplary embodiments illustrated in FIGS. 3-6.

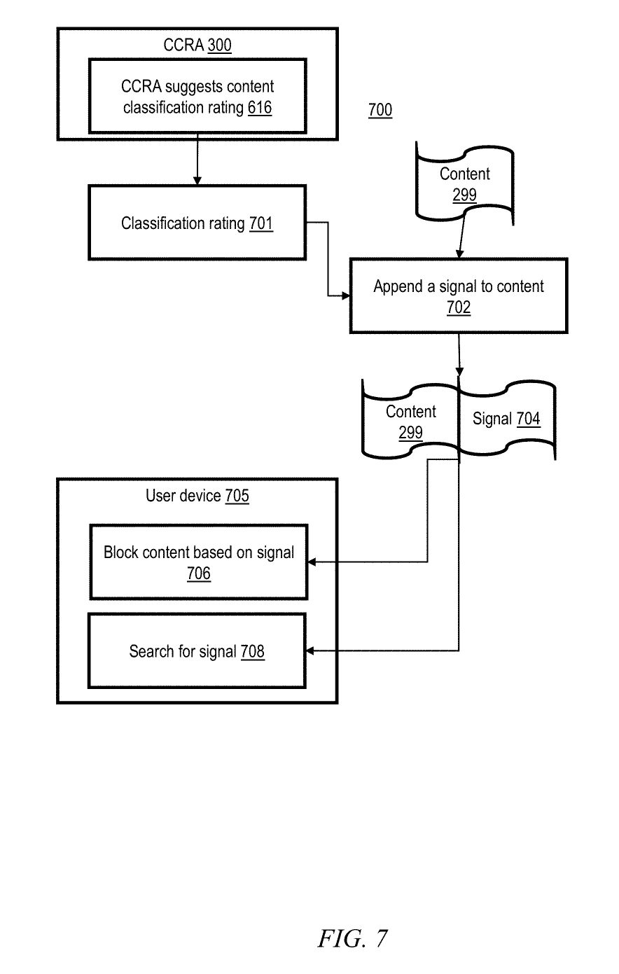

As a further step in implementation of the invention, and referring to FIG. 7, an exemplary method 700 includes appending 702 a signal 704 to the content 299 responsive to the classification rating 701 that was suggested 616 by the CCRA 300. A user device 705 may block 706 the content when the appended signal 704 exceeds a user-defined threshold. Alternatively, the user device 705 may be configured to search 708 for a given variation of the signal 704, e.g. to develop a listing of television programs rated TV-Y7.

Given the discussion thus far, and with reference to the drawing Figures, it will be appreciated that, in general terms, an exemplary method, according to an aspect of the invention, includes receiving 501 content; identifying 504 a ratings jurisdiction and regime for the content; accessing 506 a knowledge base for a trained model according to the ratings jurisdiction and regime; classifying 610 the content by testing the content against the trained model; and providing 616 to a user the classification of the content. Optionally, the exemplary method includes receiving 618, from the user, a classification feedback of the content; and updating 620 the trained model responsive to the content and the classification feedback. For example, the knowledge base may include content samples, so that updating the trained model may include adding at least portions of the content to the knowledge base as training data for the trained model.

The ordinary skilled worker will appreciate that the content may be bundled content, in which case certain implementations of the exemplary method may include decomposing 606 the bundled content to obtain items of content. Implementations of the exemplary method also may include repeatedly extracting 608 semantics, accessing the knowledge base, and classifying 610 each of the items of content, and testing the content against the trained model may include applying the trained model to the extracted semantics while updating the trained model may comprise providing the extracted semantics as additional training data. Implementations of the exemplary method for bundled content also may include aggregating 614 the classifications of the items of content.

According to certain implementations of the method, the trained model includes a collection of classification rules that are trained on content samples and classification ratings of the content samples. The classification rules may be trained on extracted semantics of the content samples, and/or on feature vectors of the content samples. Then testing the content against the trained model may include applying the classification rules to extracted semantics of the content, and/or may include applying the classification rules to feature vectors of the content. As discussed above the classification rules may be generated by supervised machine learning, using content samples, feature vectors, or semantics as training data and using the corresponding classification ratings as target attributes.

In certain implementations, the knowledge base may include content samples. Such implementations of the exemplary method may include extracting feature vectors from the content and obtaining ratings feature vectors of the content samples, such that the trained model is trained on the ratings feature vectors of the content samples, and testing the content against the trained model includes applying the trained model to the feature vectors of the content.

Embodiments of the invention may include a non-transitory computer readable medium that embodies computer executable instructions which when executed by a computer cause the computer to perform any implementation of the exemplary methods above discussed. Other embodiments of the invention may include an apparatus that includes a memory and at least one processor, coupled to said memory, and operative to implement any of the methods above discussed.

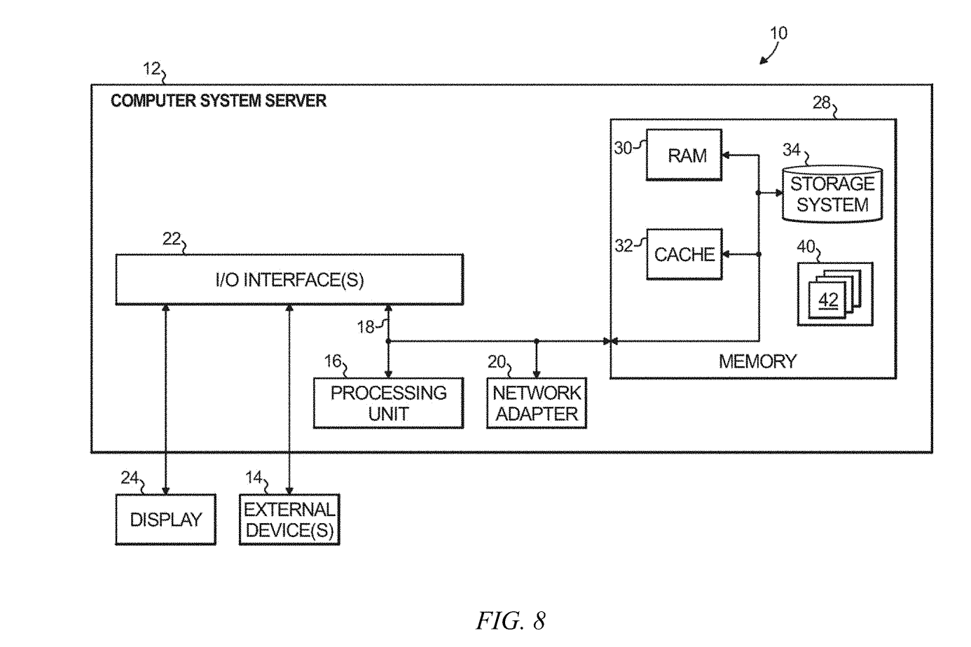

One or more embodiments of the invention, or elements thereof, can be implemented in the form of an apparatus including a memory and at least one processor that is coupled to the memory and operative to perform exemplary method steps. FIG. 8 depicts a computer system that may be useful in implementing one or more aspects and/or elements of the invention, also representative of a cloud computing node according to an embodiment of the present invention. Referring now to FIG. 8, cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

Thus, one or more embodiments can make use of software running on a general purpose computer or workstation. With reference to FIG. 8, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 8) running a server program. It will be understood that such a physical server may or may not include a display and keyboard.

One or more embodiments can be at least partially implemented in the context of a cloud or virtual machine environment, although this is exemplary and non-limiting. Reference is made back to FIGS. 1-2 and accompanying text.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors such as 16. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user's computing device to create a graphical user interface (GUI).

Exemplary System and Article of Manufacture Details

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. 2. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1.-10. (canceled)

11. A non-transitory computer readable medium embodying computer executable instructions which when executed by a computer cause the computer to implement the method of:
receiving content;
identifying a ratings jurisdiction and regime for the content;
accessing a knowledge base for a trained model according to the ratings jurisdiction and regime;
classifying the content by testing the content against the trained model;
appending a signal to the content responsive to the classification of the content;
receiving from a user a classification feedback of the content; and
updating the trained model responsive to the content and the classification feedback.

12. The medium of claim 11 wherein the trained model includes a collection of classification rules that are trained on content samples and classification ratings of the content samples.

13. The medium of claim 12 wherein the classification rules are trained on extracted semantics of the content samples, and testing the content against the trained model includes applying the classification rules to extracted semantics of the content.

14. The medium of claim 12 wherein the classification rules are trained on feature vectors of the content samples, and testing the content against the trained model comprises applying the classification rules to feature vectors of the content.

15. The medium of claim 11 wherein the knowledge base includes content samples.

16. The medium of claim 15 wherein the method further comprises extracting feature vectors from the content and obtaining ratings feature vectors of the content samples, the trained model is trained on the ratings feature vectors of the content samples, and testing the content against the trained model comprises applying the trained model to the feature vectors of the content.

17. An apparatus comprising:
a memory storing computer executable instructions; and
at least one processor, coupled in communication with the memory, and configured by the computer executable instructions to facilitate a method comprising:
receiving content;
identifying a ratings jurisdiction and regime for the content;
accessing a knowledge base for a trained model according to the ratings jurisdiction and regime;
classifying the content by testing the content against the trained model;
appending a signal to the content responsive to the classification of the content;
receiving, from a user, a classification feedback of the content; and
updating the trained model responsive to the content and the classification feedback.

18. The apparatus of claim 17 wherein the trained model includes a collection of classification rules that are trained on content samples and classification ratings of the content samples.

19. The apparatus of claim 18 wherein the classification rules are trained on extracted semantics of the content samples, and testing the content against the trained model includes applying the classification rules to extracted semantics of the content.

20. The apparatus of claim 18 wherein the classification rules are trained on feature vectors of the content samples, and testing the content against the trained model comprises applying the classification rules to feature vectors of the content.
